(19) United States
(12) Patent Application Publication
(10) Pub. No.: US 2025/0219987 A1
(43) Pub. Date: Jul. 3, 2025

(54) COMMUNICATION DEVICE, AND NON-TRANSITORY COMPUTER-READABLE RECORDING MEDIUM STORING COMPUTER-READABLE INSTRUCTIONS FOR COMMUNICATION DEVICE

(71) Applicant: BROTHER KOGYO KABUSHIKI KAISHA, Nagoya (JP)

(72) Inventor: Hiroyuki SASAKI, Chita (JP)

(21) Appl. No.: 18/990,004

(22) Filed: Dec. 20, 2024

(30) Foreign Application Priority Data
Dec. 28, 2023 (JP) 2023-222652

(51) Int. Cl. H04L 61/45; G06F 3/12; H04L 101/695

(52) U.S. Cl. CPC H04L 61/45; G06F 3/1204; G06F 3/1236; H04L 2101/695

(57) ABSTRACT

A communication device, may include: a controller; and a memory, in which the controller is configured to: in a case where it is selected by a user that one or more first-type external devices are to be searched for, specify the one or more first-type external devices; display a first search result screen indicating the one or more first-type external devices on the display; in a case where it is selected by the user that the one or more second-type external devices are to be searched for, specify the one or more second-type external devices; display a second search result screen indicating the one or more second-type external devices on the display; and in a case where a specific external device is selected on a first search result screen or a second search result screen, perform a filter process related to whether to allow communication with the specific external device.

### REFERENCE TO RELATED APPLICATIONS

This application claims priority from Japanese Patent Application No. 2023-222652 filed on Dec. 28, 2023. The entire content of the priority application is incorporated herein by reference.

### BACKGROUND ART

A home gateway is known. The home gateway has a firewall function and allows only packets including an IP address of a device allowed in advance to pass therethrough. When the home gateway detects a packet having an IP address of an unallowed device, it inquires a user whether or not to allow this device. Then, the home gateway allows the packet with the IP address of that device to pass therethrough if the user desires to allow it.

### SUMMARY

The present teachings provide an art configured to improve user convenience in a situation where a filter process regarding whether or not to allow communication between a communication device and an external device.

The present teachings disclose a communication device. The communication device may comprise: a controller, and a memory configured to, in a case where the communication device belongs to a specific subnetwork among a plurality of subnetworks constituting a local area network, store network information capable of specifying a network address of the specific subnetwork, wherein the controller is configured to: display a first selection screen on a display, the first selection screen being for selecting whether to search for, one or more first-type external devices belonging to the specific subnetwork or for one or more second-type external devices belonging to a subnetwork different from the specific subnetwork in the plurality of subnetworks; in a case where it is selected on the first selection screen by a user that the one or more first-type external devices are to be searched for, specify the one or more first-type external devices by using the network information in the memory and also by sending a search signal to outside; in a case where the one or more first-type external devices are specified, display a first search result screen indicating the one or more first-type external devices on the display; in a case where it is selected on the first selection screen by the user that the one or more second-type external devices are to be searched for, specify the one or more second-type external devices by sending a search signal to outside; in a case where the one or more second-type external devices are specified, display a second search result screen indicating the one or more second-type external devices on the display; and in a case where a specific external device is selected on the first search result screen or the second search result screen, perform a filter process related to whether to allow communication with the specific external device.

According to the above configuration, the communication device specifies the one or more first-type external devices and displays the first search result screen indicating the specified one or more first-type external devices on the display in the case where it is selected by the user on the first selection screen that the first-type external device(s) are to be searched for. Further, the communication device specifies the one or more second-type external devices and displays the second search result screen indicating the specified one or more second-type external devices on the display in the case where it is selected by the user on the first selection screen that the second-type external device(s) are to be searched for. Due to this, the user can firstly recognize the first-type external device(s) or the second-type external device(s) on the first search result screen or the second search result screen, and then select a specific external device to be a target for the filter process. Accordingly, user convenience can be improved.

The present teachings further provide a communication device. The communication device may comprise: a controller; and a memory configured to, in a case where the communication device belongs to a specific subnetwork among a plurality of subnetworks constituting a local area network, store network information capable of specifying a network address of the specific subnetwork, wherein the controller is configured to: specify, by sending a search signal to outside, a plurality of external devices, each of which belongs to the specific subnetwork or one or more other subnetworks different from the specific subnetwork in the plurality of subnetworks; specify from among the plurality of external devices, by using the network information in the memory, one or more first-type external devices belonging to the specific subnetwork and one or more second-type external devices belonging to the one or more other subnetworks; display a search result screen on a display, the search result screen indicating the one or more first-type external devices and the one or more second-type external devices in a distinguishable form by which the one or more first-type external devices and the one or more second-type external devices are distinguishable; and in a case where a specific external device is selected on the search result screen, perform a filter process related to whether to allow communication with the specific external device.

According to the above configuration, the communication device specifies the one or more first-type external devices and the one or more second-type external devices from among the plurality of external devices, each of which belongs to the specific subnetwork or the one or more other subnetworks among the plurality of subnetworks, and displays the search result screen indicating these first-type external device(s) and the second-type external device(s) in the distinguishable form on the display. Due to this, the user can firstly recognize the first-type external device(s) or the second-type external device(s) distinctively on the search result screen, and then select a specific external device to be a target for the filter process. Accordingly, user convenience can be improved.

A non-transitory computer-readable storage medium storing computer-readable instructions for a communication device and a method executed by the above-described communication device are also novel and useful.

### BRIEF DESCRIPTION OF DRAWINGS

FIG. 1 illustrates a configuration of a communication system.

FIG. 2 illustrates a configuration of a printer and a terminal.

FIG. 3 illustrates a sequence diagram of a first embodiment.

FIG. 4 illustrates a screen flow diagram of the first embodiment.

FIG. 5. Illustrates a screen flow diagram continued from FIG. 4.

FIG. 6 illustrates a flowchart of an IP address update process which is started with activation of a printer as a trigger.

FIG. 7 illustrates a flowchart of an IP address update process which is started at a predetermined timing, and

FIG. 8 illustrates a screen flow diagram of a second embodiment.

FIG. 9 illustrates a screen flow diagram continued from FIG. 8.

### DESCRIPTION

### First Embodiment

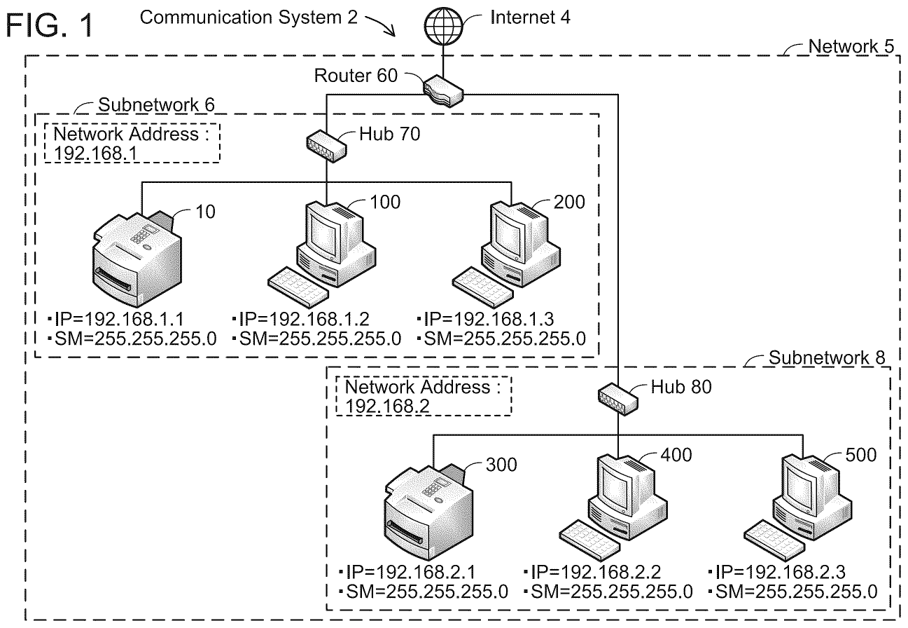

### (Configuration of Communication System 2; FIG. 1)

As shown in FIG. 1, a communication system 2 comprises a network 5 composed of a plurality of subnetworks 6, 8. The network 5 is formed in a facility such as a company, a university/college. For example, the subnetwork 6 is formed in a department of the company and the subnetwork 8 is formed in another department of the company. The network 5 comprises a router 60 configured to enable each device within the network 5 to communicate via the Internet 4. The subnetwork 6 comprises a switching hub 70, a printer 10, and a plurality of terminals 100, 200. The subnetwork 8 comprises a switching hub 80, a printer 300, and a plurality of terminals 400, 500.

### (Configuration of Router 60)

The router 60 does not only have a function of relaying communication via the Internet 4, but also has a Dynamic Host Configuration Protocol (DHCP) server function, and a Domain Name System (DNS) server function. The DHCP server function is a function of assigning an IP address to each device belonging to the network 5. For example, when the router 60 receives an IP address assign request from a certain device within the network 5, the router 60 selects one IP address from within a predetermined range of IP addresses and sends the selected IP address and a predetermined subnet mask to the certain device. The IP address herein assigned by the router 60 is variable (i.e., dynamic IP address). In a modification, a DHCP server different from the router 60 may be disposed in the network 5.

The DNS server function is a function used for so-called name resolution. The router 60 stores, for each of the plurality of devices belonging to the network 5, a device name of the device and an IP address of the device (e.g., IP address assigned by the DHCP server function of the router 60) in association with each other. For example, a situation in which a device name “PC100” of the terminal 100 and the IP address of the terminal 100 are registered in the router 60 in association with each other will be assumed. In this case, when the router 60 receives an inquiry request including the device name “PC100” of the terminal 100 from the printer 10, the router 60 sends an inquiry response including the IP address associated with the device name “PC100” to the printer 10. Due to this, the printer 10 can acknowledge the IP address of the terminal 100. That is, the printer 10 can execute name resolution. In a modification, a DNS server different from the router 60 may be disposed on the network 5.

The network address of the subnetwork 6 is “192.168.1”. As indicated by “SM (abbreviation for Subnet Mask)” in FIG. 1, a same subnet mask “255.255.255.0” is assigned to each of the devices 10, 100, 200 belonging to the subnetwork 6. The printer 10 is assigned an IP address “192.168.1.1”. The printer 10 has a device name “PR10”. The terminal 100 is assigned an IP address “192.168.1.2”. The terminal 100 has the device name “PC100”. The terminal 200 is assigned an IP address “192.168.1.3”. The terminal 200 has a device name “PC200”. The devices 10, 100, 200 are connected to the router 60 via the switching hub 70.

The network address of the subnetwork 8 is “192.168.2”. A same subnet mask “255.255.255.0” is assigned to each of the devices 300, 400, 500 belonging to the subnetwork 6. The printer 300 is assigned an IP address “192.168.2.1”. The printer 300 has a device name “PR300”. The terminal 400 is assigned an IP address “192.168.2.2”. The terminal 400 has a device name “PC400”. The terminal 500 is assigned an IP address “192.168.2.3”. The terminal 500 has a device name “PC500”. The devices 300, 400, 500 are connected to the router 60 via the switching hub 80.

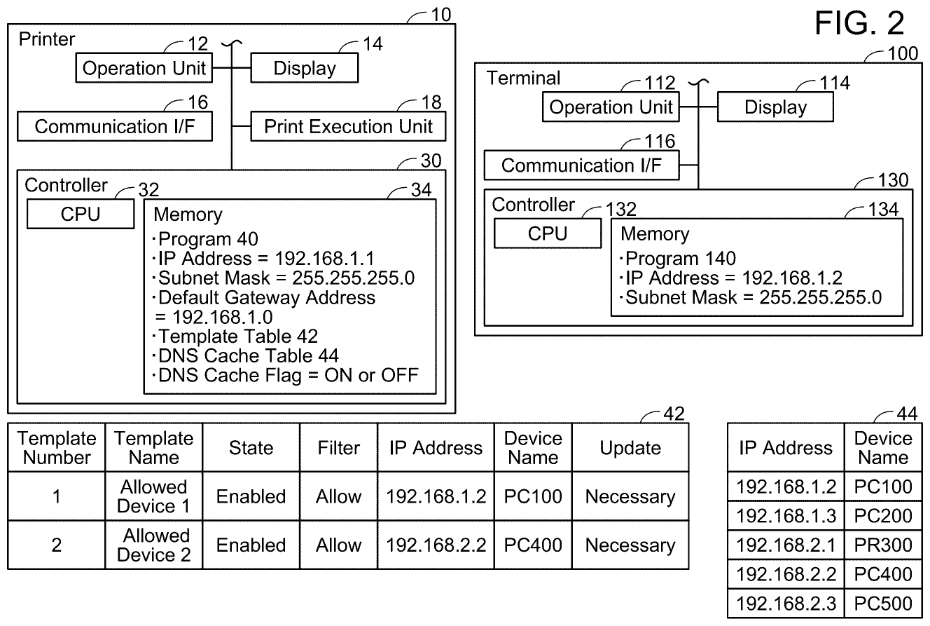

### (Configuration of Printer 10; FIG. 2)

The printer 10 is a peripheral device configured to execute a print function (e.g., a peripheral device of the terminals 100, 200). The printer 10 comprises an operation unit 12, a display 14, a communication interface 16, a print execution unit 18, and a controller 30. Hereafter, an interface will be referred to as “I/F”.

The operation unit 12 comprises a plurality of keys. A user can input various instructions to the printer 10 by operating the operation unit 12. The display 14 is a display configured to display various information. The display 14 functions also as a so-called touch panel (i.e., operation unit). The communication I/F 16 is connected to the switching hub 70. The communication I/F 16 may be a wireless I/F or a wired I/F. The print execution unit 18 comprises a print mechanism such as ink jet scheme or laser scheme.

The controller 30 comprises a CPU 32 and a memory 34. The memory 34 comprises an unillustrated primary storage and an unillustrated auxiliary storage. The CPU 32 executes various processes in accordance with a program 40 stored in the auxiliary storage of the memory 34. Specifically, the CPU 32 executes the above-mentioned various processes by loading the program 40 from the auxiliary storage to the primary storage and executing the program 40. The primary storage is for example a RAM and cache memory. The auxiliary storage may be for example a flash memory, an SSD (Solid State Drive), or a ROM, or may be a combination thereof.

The memory 34 further stores the IP address of the printer 10 itself “192.168.1.1”, the subnet mask of the printer 10 “255.255.255.0”, and a default gateway address “192.168.1.0”. The default gateway address is an IP address of the router 60.

The memory 34 further stores a template table 42. The template table 42 can store a plurality of templates. Each template has a template number (e.g., “1”, “2”), a template name “Allowed Device 1”, “Allowed Device 2”), state information (e.g., “Enabled”), filter information (e.g., “Allow”), an IP address (e.g., “192.168.1.2”, “192.168.2.2”), a device name (e.g., “PC100”, “PC400”), and update information (“Necessary”) all associated with one another.

The template number is information for identifying the template. Although this is an example, the template number may be an integer being one of 1 to 16. The template name is a name of the template designated by the user. The state information indicates either “Enabled” meaning using of the template or “Disabled” meaning not using of the template. The filter information is information related to whether or not to allow communication between a device identified by device information (i.e., IP address and device name) included in the template and the printer 10. The filter information indicates either “Allow” meaning allowing the communication or “Deny” meaning not allowing the communication. The update information indicates either “Necessary” meaning updating the IP address included in the template and “Unnecessary” meaning not updating the IP address.

As mentioned above, the router 60 has the DHCP server function. Accordingly, each device 10, 100, 200, etc., connected to the router 60 is assigned a dynamic IP address. The IP address of each device may change at a timing when the device is activated, for example. In order to cope with such phenomenon, the update information “Necessary” is stored. For example, when the IP address of a certain device is a static IP address not a dynamic IP address, “Unnecessary” may be stored as the update information included in the template for the certain device.

The memory 34 further stores a DNS cache table 44. The DNS cache table 44 has an IP address (e.g., “192.168.1.2”) and a device name (e.g., “PC100”) stored in association with one another. Each time the router 60, which has the DNS server function, assigns a device an IP address, the router 60 stores the IP address and the device name of the device in association with each other. The printer 10 sends a request signal for requesting each stored IP address to be sent to the router 60 and in turn receives a plurality of combination information from the router 60. Each piece of the combination information includes the IP address assigned by the router 60 and the device name of the device which is assigned that IP address. The DNS cache table 44 is a table for storing (i.e., caching) the plurality of combination information received from the router 60.

The memory 34 further stores a DNS cache flag. The DNS cache flag indicates either “ON” indicating that the template table 42 has not been updated by using the latest DNS cache table 44 yet or “OFF” indicating the template table 42 is already updated by using the latest DNS cache table 44. For example, when the printer 10 receives the plurality of pieces of the combination information from the router 60, the printer 10 updates the DNS cache table 44. In this case, the printer 10 switches the DNS cache flag from “OFF” to “ON”. Then, when the printer 10 has updated the template table 42 by using the latest DNS cache table 44 in processes to be described later, the printer 10 switches the DNS cache flag from “ON” to “OFF”.

### (Configuration of Terminal 100)

The terminal 100 is an administrator terminal used by an administrator of each device belonging to the network 5. The terminal 100 is for example a desktop PC, a laptop PC, a tablet PC, a smartphone, or a PDA. The terminal 100 comprises an operation unit 112, a display 114, a communication I/F 116, and a controller 130.

The operation unit 112 comprises a plurality of keys. The user can input various instructions to the terminal 100 by operating the operation unit 112. The display 114 is a display configured to display various information. The display 114 may function also as a touch panel (i.e., operation unit). The communication I/F 116 is connected to the switching hub 70. The communication I/F 16 may be a wireless I/F or may be a wired I/F.

The controller 130 comprises a CPU 132 and a memory 134. The memory 134 comprises an unillustrated primary storage and an unillustrated auxiliary storage. The CPU 132 executes various processes in accordance with a program 140 stored in the auxiliary storage of the memory 134. Specifically, the CPU 132 executes the above-mentioned various processes by loading the program 140 from the auxiliary storage to the primary storage and executing the program 140. The primary storage is for example a RAM and cache memory. The auxiliary storage may be for example a flash memory, an SSD (Solid State Drive), or a ROM, or may be a combination thereof. The memory 134 further stores the IP address of the terminal 100 itself “192.168.1.2” and the subnet mask of the terminal 100 “255.255.255.0”.

### (Configurations of Other Devices 200, 300, 400, 500)

Each terminal 200, 400, 500 is used by a general user different from the administrator. Each terminal 200, 400, 500 has the same configuration as the terminal 100 except that each terminal 200, 400, 500 stores the IP address of the terminal itself. The printer 300 has the same configuration as the printer 10 except that the printer 300 stores the IP address of the printer 300 itself.

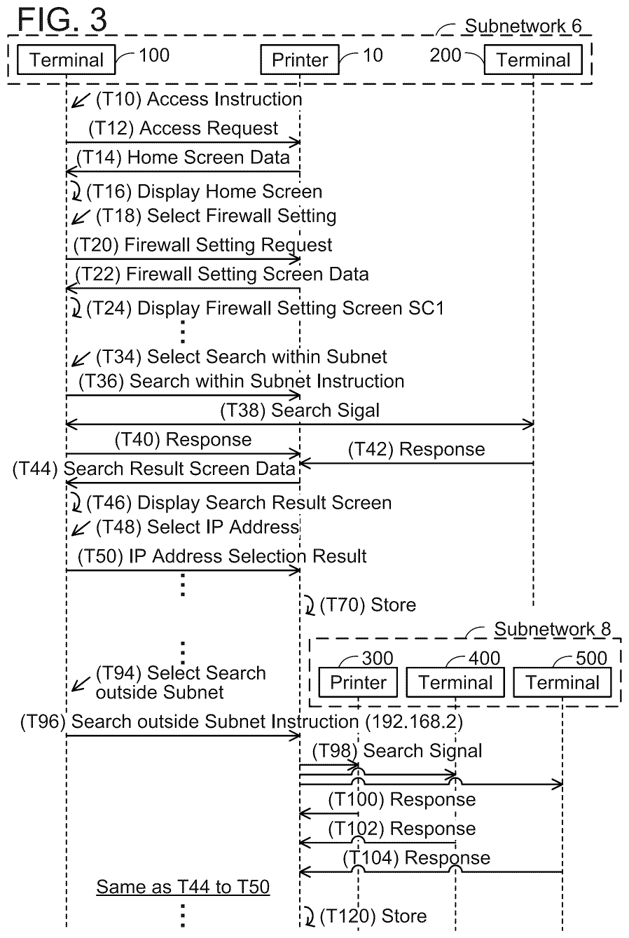

### (Specific Processes; FIGS. 3 to 5)

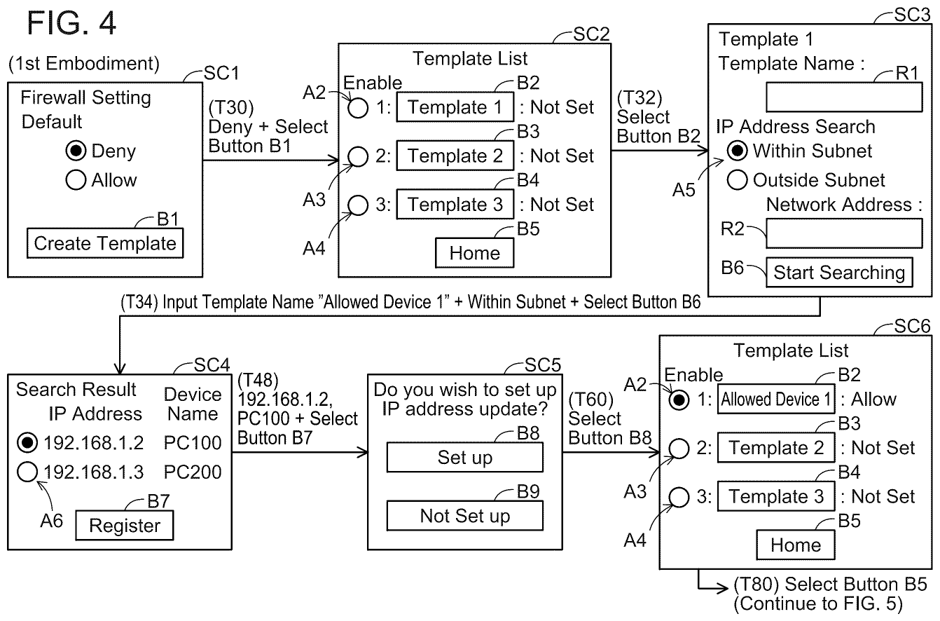

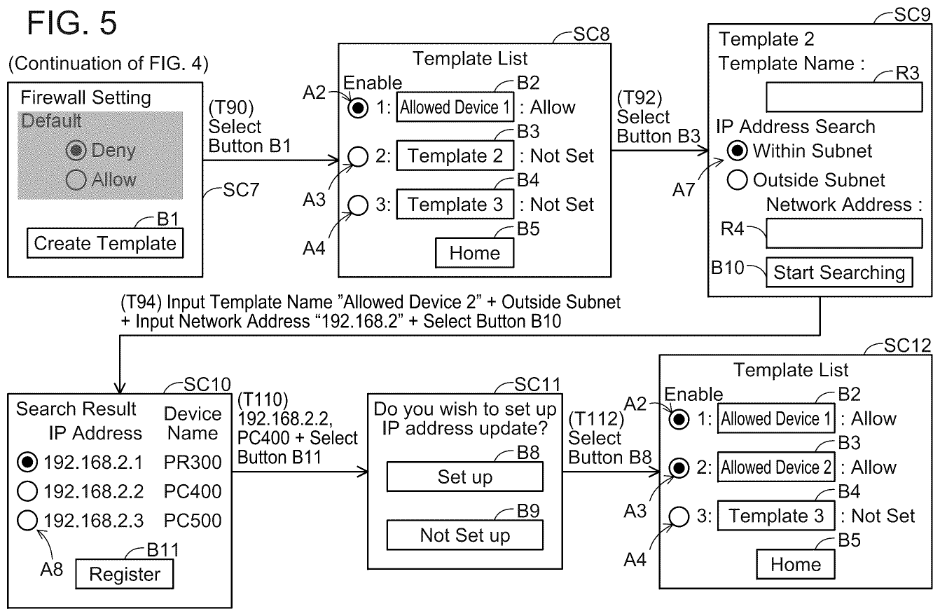

With reference to FIGS. 3 to 5, a process of storing a template in the template table 42 of the printer 10 will be described. Hereafter, for easier understanding, when describing a process executed by the CPU 132 of the terminal 100 in accordance with the program 40, 140, the process is not described with each CPU 32, 132 as a subject of action, but described with the printer 10/the terminal 100 as a subject of action. Also, all the communication executed by the printer 10/the terminal 100 is executed via the communication I/F 16, 116. Accordingly, hereafter, when describing the process related to communication, a recitation “via the communication I/F 16 (or 116)” will be omitted. At an initial state of FIG. 3, any information is not stored yet in the template table 42 of the printer 10. In FIG. 3, a part of the communication and the process for displaying the respective screens in FIGS. 4 and 5 is omitted from illustration.

In T10, the terminal 100 receives an access instruction including an operation of inputting an IP address of a webserver in the printer 10 from the user. In this case, in T12, the terminal 100 sends an access request including the IP address as a destination address to the printer 10.

In T12, the printer 10 receives the access request from the terminal 100. The printer 10 is configured to function as a webserver, and thus send screen data representing various web pages to the terminal 100. In T14, firstly, the printer 10 sends home screen data representing a home screen to the terminal 100.

In T14, the terminal 100 receives the home screen data from the printer 10. In T16, the printer 10 displays the home screen (not shown). The home screen includes a plurality of buttons for executing various settings related to the printer 10. The plurality of buttons includes a button indicating firewall setting. The firewall setting is setting related to communication of the printer 10, and more specifically, is setting related to whether to allow or deny communication with which device. When in T18 the terminal 100 receives a selection of that button from the user, in T20 the terminal 100 sends a firewall setting request to the printer 10.

When in T20 the printer 10 receives the firewall setting request from the terminal 100, in T22 the printer 10 sends firewall setting screen data representing a firewall setting screen to the terminal 100.

When in T22 the terminal 100 receives the firewall setting screen data from the printer 10, in T24 the terminal 100 displays a firewall setting screen SC1 (see FIG. 4). Hereafter, subsequent processes will be described with reference to FIGS. 4 and 5 also.

As shown in FIG. 4, the firewall setting screen SC1 includes an area for designating a default policy related to the communication of the printer 10. This area includes a “Deny” button meaning denying communication of the printer 10 in principle and an “Allow” button meaning allowing communication of the printer 10 in principle. For example, when the “Deny” button is selected by the user for example, i.e., when “Deny” is designated as the default policy of the printer 10, the printer 10 denies communication with any device in principle. The printer 10 can however exceptionally allow communication with a device designated by a template to be described later. That is, in this case, the template functions as a white list indicating a device with which communication is possible. Further, when the “Allow” button is selected by the user for example, that is, when “Allow” is designated as the default policy of the printer 10, the printer 10 allows communication with any device in principle. The printer 10 can however exceptionally deny communication with a device designated by a template to be described later. That is, in this case, the template functions as a black list indicating a device with which communication cannot be executed. The firewall setting screen SC1 further includes a Create Template button B1.

When in T30 the terminal 100 receives selection of the default policy “Deny” and selection of the Create Template button B1, the terminal 100 sends a template create request (not shown in FIG. 3) to the printer 10.

When the printer 10 receives the template create request from the terminal 100, the printer 10 sends a template list screen data (not shown in FIG. 3) representing a template list screen SC2 to the terminal 100.

When the terminal 100 receives the template list screen data from the printer 10, the terminal 100 displays the template list screen SC2. The template list screen SC2 is a screen for selecting one template from among the plurality of templates. The template list screen SC2 includes buttons B2 to B4 corresponding to each template. The template list screen SC2 further includes radio buttons A2 to A4 respectively corresponding to the buttons B2 to B4. When the radio button A2 for example is in a selected state, the template corresponding to the radio button is enabled, and when the radio button A2 for example is in an unselected state, the template corresponding to the radio button is disabled. Further, a rule is not currently specified for each template shown on the template list screen SC2, and thus a character string “Not Set” is arranged to the right of each of the respective buttons B2 to B4. The template list screen SC2 further includes a Home button B5 for returning to the firewall setting screen SC1.

In T32, when the terminal 100 receives selection of the button B2 from the user, the terminal 100 sends the template create request (not shown in FIG. 3) including the template number “1” corresponding to the button B2 to the printer 10.

When the printer 10 receives a template create setting request from the terminal 100, the printer 10 sends template setting screen data (not shown in FIG. 3) representing a template setting screen SC3 to the terminal 100.

When the terminal 100 receives the template setting screen data from the printer 10, the terminal 100 displays the template setting screen SC3. The template setting screen SC3 includes the template number “1”, a template name input area R1, a radio button A5 for selecting an IP address search method, a network address input area R2, and a Start Searching button B6. The template name input area R1 is for receiving an input of a template name from the user. The radio button A5 is for selecting whether to search for, the IP address of each of device(s) within the subnetwork 6 to which the printer 10 belongs (“Within Subnet” button) or for the IP address of each of device(s) outside the subnetwork 6 to which the printer 10 belongs (“Outside Subnet” button).

In T34, the terminal 100 receives input of a template name “Allowed Device 1”, selection of the “Within Subnet” button, and selection of the Start Searching button B6 from the user. In this case, as shown in FIG. 3, in T36, the terminal 100 sends a ‘search within subnet’ instruction to the printer 10. The ‘search within subnet’ instruction includes the template name “Allowed Device 1” and information indicating that the “Within Subnet” button has been selected.

When in T36 the printer 10 receives the ‘search within subnet’ instruction from the terminal 100, the printer 10 specifies a network address “192.168.1” of the subnetwork 6 to which the printer 10 belongs by masking the IP address “192.168.1.1” of the printer 10 itself with the subnet mask “255.255.255.0” of the printer 10. Then, in T38, the printer 10 sends a broadcast search signal including a broadcast address “192.168.1.255 of the specified network address “192.168.1” as a destination address and also including the IP address “192.168.1.1” as a sender address. Due to this, the search signal is received by the respective devices 100, 200 within the subnetwork 6. In a modification, in T38, the printer 10 may send a search signal by designating 8-bit values (i.e., host address) lower than the network address “192.168.1” as a destination IP address. That is, in the above-mentioned example, the IP addresses from “192.168.1.0” to “192.168.1.254” are designated.

When in T38 the terminal 100 receives the search signal from the printer 10, in T40 the terminal 100 sends a response signal to the printer 10. This response signal includes the IP address “192.168.1.1” of the printer 10 as a destination address and also including the IP address “192.168.1.2” of the terminal 100 itself as a sender address. This response signal further includes the device name “PC100” of the terminal 100.

When in T38 the terminal 200 receives the search signal from the printer 10, in T42 the terminal 200 sends a response signal to the printer 10. This response signal includes the IP address “192.168.1.1” of the printer 10 as a destination address and also including the IP address “192.168.1.3” of the terminal 200 itself as a sender address. This response signal further includes the device name “PC200” of the terminal 200.

When in T40 and T42 the printer 10 receives the response signal from both of the terminal 100 and the terminal 200, the printer 10 specifies a combination of the IP address “192.168.1.2” of the terminal 100 and the device name “PC100” that are included in the response signal received from the terminal 100, and further specifies a combination of the IP address “192.168.1.3” of the terminal 200 and the device name “PC200” that are included in the response signal received from the terminal 200. Then in T44 the printer 10 sends search result screen data including the respective specified combinations to the terminal 100.

When in T44 the terminal 100 receives the search result screen data from the printer 10, in T46 the terminal 100 displays a search result screen SC4 (see FIG. 4) represented by the search result screen data. As shown in FIG. 4, the search result screen SC4 includes the combination of the IP address “192.168.1.2” and the device name “PC100” and the combination of the IP address “192.168.1.3” and the device name “PC200”. The search result screen SC4 further includes a radio button A6 corresponding to each combination and a Register button B7. In T48, the terminal 100 receives selection of the radio button corresponding to the combination of the IP address “192.168.1.2” and the device name “PC100” and selection of the Register button B7. In this case, as shown in FIG. 3, in T50 the terminal 100 sends an IP address selection result including the IP address “192.168.1.2” and the device name “PC100” to the printer 10.

When in T50 the printer 10 receives the IP address selection result from the terminal 100, the printer 10 sends IP address update setting screen data (not shown in FIG. 3) representing an IP address update setting screen SC5 to the terminal 100.

When the terminal 100 receives the IP address update setting screen data from the printer 10, the terminal 100 displays the IP address update setting screen SC5. As shown in FIG. 4, the IP address update setting screen SC5 includes a message inquiring the user of whether to set up for IP address update or not, a “Set up” button B8, and a “Not Set up” button B9.

When in T60 the terminal 100 receives selection of the “Set up” button B8 from the user, the terminal 100 sends a update selection result (not shown in FIG. 3) indicating that the “Set up” button B8 has been selected to the printer 10.

When the printer 10 receives the update selection result from the terminal 100, as shown in FIG. 3, in T70 the printer 10 executes a template storing process. Specifically, the printer 10 stores the template number “1” included in the template create request received according to T32 in FIG. 4, the IP address “192.168.1.2” included in the IP address selection result of T50 in FIG. 3, and the device name “PC100” included in the same IP address selection result in association with each other in the template table 42. The printer 10 further stores the update information “Necessary” in association with the template number “1” because the update selection result received according to T60 in FIG. 4 indicates “Set up”. Further, because the current default policy is set to “Deny”, the printer 10 stores the filter information “Allow”, which is opposite from “Deny”, in association with the template number “1”. Then, the printer 10 stores the state information indicating “Enabled” in association with the template number “1”. When a template is newly created, the state information indicating “Enabled” is stored as default.

According to the above-mentioned respective processes, the template identified by the template number “1” is registered in the template table 42. Due to this, the printer 10 denies communication with any device in principle, but the printer 10 exceptionally allows communication with the terminal 100 designated by the template number “1”. Then, the printer 10 sends template list screen data (not shown in FIG. 3) representing a template list screen SC6 to the terminal 100.

When the terminal 100 receives the template list screen data from the printer 10, the terminal 100 displays the template list screen SC6. The template list screen SC6 is the same as the template list screen SC2 except for the following points. The button B2 corresponding to the template “1” indicates “Allowed Device 1” instead of “Template 1”. The radio button A2 corresponding to the button B2 is in the selected state, instead of being in the unselected state. The radio button A2 corresponding to the button B2 is in the selected state instead of being in the unselected state. “Allow” is displayed to the right of the button B2, instead of the character string “Not Set”.

When in T80 the terminal 100 receives selection of the Home button B5 from the user, the terminal 100 sends a home screen request (not shown in FIG. 3) to the printer 10.

When the printer 10 receives the home screen request from the terminal 100, the printer 10 sends the firewall setting screen data (not shown in FIG. 3) representing a firewall setting screen to the terminal 100.

When the terminal 100 receives the firewall setting screen data from the printer 10, the terminal 100 displays the firewall setting screen SC7. As shown in FIG. 5, in the firewall setting screen SC7, an area for designating the default policy has a form which the user cannot select. That is, this area has a so-called grayed out form. For the other points, the firewall setting screen SC7 is the same as the firewall setting screen SC1 in FIG. 4.

When in T90 the terminal 100 receives selection of the Create Template button B1 from the user, the terminal 100 sends the template create request (not shown in FIG. 3) to the printer 10.

When the printer 10 receives the template create request from the terminal 100, the printer 10 sends the template list screen data (not shown in FIG. 3) representing a template list screen to the terminal 100.

When the terminal 100 receives the template list screen data from the printer 10, the terminal 100 displays the template list screen SC8. The template list screen SC8 is the same as the template list screen SC6 in FIG. 4. When in T92 the terminal 100 receives selection of the button B3 from the user, the terminal 100 sends the template create request (not shown in FIG. 3) including the template number “2” corresponding to the button B3 to the printer 10.

When the terminal 100 receives the template setting screen data from the printer 10, the terminal 100 displays a template setting screen SC9. The template setting screen SC9 is the same as the template setting screen SC3 in FIG. 4 except that the template setting screen SC9 indicates the template number “2”. Respective areas R3, R4, and buttons A7, B10 are the same as the respective areas R1, R2, and the buttons A5, B6.

In T94, the terminal 100 receives input of the template name “Allowed Device 2”, selection of the button “Outside Subnet”, input of the network address “192.168.2”, and selection of a Start Searching button B10 from the user. In this case, as shown in FIG. 3, in T96 the terminal 100 sends a ‘search outside subnet’ instruction to the printer 10. The ‘search outside subnet’ instruction includes the template name “Allowed Device 2”, information indicating that the “Outside Subnet” button has been selected, and the network address “192.168.2”. When in T96 the printer 10 receives the ‘search outside subnet’ instruction from the terminal 100, in T98 the printer 10 sends a search signal including the IP addresses from the IP address “192.168.2.0” to “192.168.2.254” included in the ‘search outside subnet’ instruction as a destination address and also including the IP address “192.168.1.1” as a sender address. Because the outside of the subnetwork 6 to which the printer 10 belongs is designated as the destination address, the search signal is sent toward the default gateway address “192.168.1.0” (i.e., IP address of the router 60) already stored in the memory 34. Then the search signal is forwarded, via the router 60, to the subnetwork 8 having the network address “192.168.2”. Due to this, the search signal is received by each of the devices 300, 400, 500 within the subnetwork 8.

When in T98 the printer 300 receives the search signal from the printer 10, in T100 the printer 300 sends a response signal to the printer 10. This response signal includes the IP address “192.168.1.1” of the printer 10 as a destination address and also includes the IP address “192.168.2.1” of the printer 300 itself as a sender address. This response signal further includes the device name “PR300” of the printer 300.

When in T98 the terminal 400 receives the search signal from the printer 10, in T102 the terminal 400 sends a response signal to the printer 10. This response signal includes the IP address “192.168.1.1” of the printer 10 as a destination address and also includes the IP address “192.168.2.2” of the terminal 400 itself as a sender address. This response signal further includes the device name “PC400” of the terminal 400.

When in T98 the terminal 500 receives the search signal from the printer 10, in T104 the terminal 500 sends a response signal to the printer 10. This response signal includes the IP address “192.168.1.1” of the printer 10 as a destination address and also includes the IP address “192.168.2.3” of the terminal 500 itself as a sender address. This response signal further includes the device name “PC500” of the terminal 500.

When in T100 to T104 the printer 10 receives the response signal from each of the printer 300, the terminal 400, and the terminal 500, the printer 10 specifies combinations of an IP address and a device name included in the respective response signals. Specifically, the printer 10 specifies a combination of the IP address “192.168.2.1” and the device name “PR300” of the printer 300, a combination of the IP address “192.168.2.2” and the device name “PC400” of the terminal 400, and a combination of the IP address “192.168.2.3” and the device name “PC500” of the terminal 500. Then, in cited T44, the printer 10 sends the search result screen data including the above-mentioned specified combinations to the terminal 100.

When in cited T44 the terminal 100 receives the search result screen data from the printer 10, in cited T46 the terminal 100 displays a search result screen SC10 (see FIG. 5) represented by the search result screen data. As shown in FIG. 5, the search result screen SC10 includes the above-mentioned three combinations. The search result screen SC10 further includes a radio button A8 corresponding to each combination and a Register button B11. In T110 (i.e., T48 cited in FIG. 3), the terminal 100 receives, from the user, selection of the radio button corresponding to the combination of the IP address “192.168.2.2” and the device name “PC400” and selection of the Register button B11. In this case, as shown in FIG. 3, in cited T50, the terminal 100 sends the IP address selection result including the IP address “192.168.2.2” and the device name “PC400” to the printer 10.

When in cited T50, the printer 10 receives the IP address selection result from the terminal 100, the printer 10 sends the IP address update setting screen data representing an IP address update setting screen SC11 to the terminal 100.

When the terminal 100 receives the IP address update setting screen data from the printer 10, the terminal 100 displays the IP address update setting screen SC11. As shown in FIG. 5, the IP address update setting screen SC11 is the same as the IP address update setting screen SC5 in FIG. 4. When in T112 the terminal 100 receives selection of the “Set up” button B8 from the user, the terminal 100 sends the update selection result indicating that the “Set up” button B8 has been selected to the printer 10.

When the printer 10 receives the update selection result from the terminal 100, as shown in FIG. 3, in T120 the printer 10 executes the template storing process. Specifically, the printer 10 stores the template number “2” included in the template create request received according to T92 in FIG. 5, the IP address “192.168.2.2” included in the IP address selection result of T50 cited in FIG. 3, and the device name “PC400” included in the same IP address selection result in association with each other in the template table 42. Because the update selection result received according to T112 in FIG. 5 indicates “Set up”, the printer 10 further stores the update information indicating “Necessary” in association with the template number “2”. Further, because the current default policy is set to “Deny”, the printer 10 stores the filter information indicating “Allow”, which is opposite from “Deny”, in association with the template number “2”. Then, the printer 10 stores the state information indicating “Enabled” in association with the template number “2”.

According to the above-mentioned respective processes, the information regarding the template number “2” is registered in the template table 42. Due to this, the printer 10 denies communication with any device in principle, but the printer 10 can exceptionally allow communication with the terminal 100 designated by the template number “1” and the terminal 400 designated by the template number “2”. That is, the process of storing the template in T70 or T120 is a filter process of denying communication between an external device and the printer 10 in principle but allowing communication between device(s) selected by the user and the printer 10. Then the printer 10 sends the template list screen data representing the template list screen SC12 to the terminal 100.

When the terminal 100 receives the template list screen data from the printer 10, the terminal 100 displays the template list screen SC12. The template list screen SC12 is the same as the template list screen SC6 except for the following points. The button B3 indicates “Allowed Device 2” instead of “Template 2”. The radio button A3 corresponding to the button B3 is in the selected state instead of being in the unselected state. “Allow” is displayed instead of the character string “Not Set” to the right of the button B3.

According to the above configuration, in a case where it is selected on the template setting screen SC3 in FIG. 4 by the user that each device within the subnetwork 6 to which the printer 10 belongs is to be searched for (T34 in FIG. 3), the printer 10 specifies the network address “192.168.1” of the subnetwork 6 by masking the IP address “192.168.1.1” of the printer 10 itself with the subnet mask “255.255.255.0” of the printer 10. Then, the printer 10 specifies the respective devices 100, 200 within the subnetwork 6 by sending a search signal including a broadcast address “192.168.1.255” of the specified network address “192.168.1” as a destination address (T38). Specifically, the printer 10 specifies the combination of the IP address “192.168.1.2” and the device name “PC100” of the terminal 100 and the combination of the IP address “192.168.1.3” and the device name “PC200” of the terminal 200 included in the response signal received from the terminal 200. Then the printer 10 displays the search result screen SC4 including the specified respective combinations on the display 114 of the terminal 100 (T44).

Also, when it is selected on the template setting screen SC9 in FIG. 5 by the user that each device belonging outside the subnetwork 6 to which the printer 10 belongs is to be searched for (T94 in FIG. 3), the printer 10 specifies the respective devices 300, 400, 500 within the subnetwork 8 by sending a search signal including a network address “192.168.2” different from the network address “192.168.1” of the subnetwork 6 and inputted by the user as a destination address (T98). Specifically, the printer 10 specifies a combination of the IP address “192.168.2.1” and the device name “PR300” of the printer 300, a combination of the IP address “192.168.2.2” and the device name “PC400” of the terminal 400, and a combination of the IP address “192.168.2.3” and the device name “PC500” of the terminal 500. Then the printer 10 displays the search result screen SC10 including the specified respective combinations on the display 114 of the terminal 100 (T44 cited after T104 in FIG. 3).

Due to this, in the search result screen SC4 or the search result screen SC10, the user can firstly acknowledge the devices 100, 200 within the subnetwork 6 to which the printer 10 belongs or the devices 300, 400, 500 within the subnetwork 8 different from the subnetwork 6, and then can select the devices 100, 400 to be targets for the filter process. Accordingly, user convenience can be improved.

Here, a case where the “Allow” button is selected by the user on the firewall setting screen SC1 in FIG. 4, that is, a case where “Allow” is designated as the default policy of the printer 10 will be described. When the terminal 100 receives selection of the default policy “Allow” and selection of the Create Template button B1 from the user on the firewall setting screen SC1, the terminal 100 displays the template list screen SC2. When the terminal 100 receives selection of the button B2 from the user on the template list screen SC2 by the respective operations same as those aforementioned being performed, the terminal 100 sends the template create request to the printer 10 and displays the template setting screen SC3. When the terminal 100 receives input of a template name “Allowed Device 1”, selection of the “Within Subnet” button, and selection of the Start Searching button B6 from the user on the template setting screen SC3, the terminal 100 sends the ‘search within subnet’ instruction to the printer 10.

The printer 10 receives the ‘search within subnet’ instruction from the terminal 100. Thereafter, the same processes as T38 to T60 in FIGS. 3, 4 are executed in the printer 10 and the respective terminals 100, 200.

When the printer 10 receives the update selection result from the terminal 100, the printer 10 executes the template storing process. Specifically, the printer 10 stores the template number “1” included in the template create request, the IP address “192.168.1.2” included in the IP address selection result in T50 of FIG. 3, and the device name “PC100” included in the same IP address selection result in association with each other in the template table 42. Because the update selection result received according to T60 in FIG. 4 indicates “Set up”, the printer 10 stores the update information “Necessary” in association with the template number “1”. Further, because the current default policy is set to “Allow”, the printer 10 stores the filter information indicating “Deny”, which is opposite from “Allow”, in association with the template number “1”. Then the printer 10 stores the state information “Enabled” in association with the template number “1”.

According to the above-mentioned respective processes, the information regarding the template number “1” is registered in the template table 42. Due to this, the printer 10 allows communication with any device in principle, but the printer 10 can exceptionally deny communication with the terminal 100 designated by the template number “1”. That is, the process of storing the template in the present case is a filter process of allowing communication between an external device and the printer 10, but denying communication between device(s) selected by the user and the printer 10. Alternatively, in the template setting screen SC3, the “Outside Subnet” button may be selected by the user instead of the “Within Subnet” button. In this case also, the process of storing the template is a filter process of allowing communication between an external device and the printer 10 in principle but denying communication between a certain device (e.g., one of the devices 300, 400, 500) outside the subnetwork 6 and the printer 10.

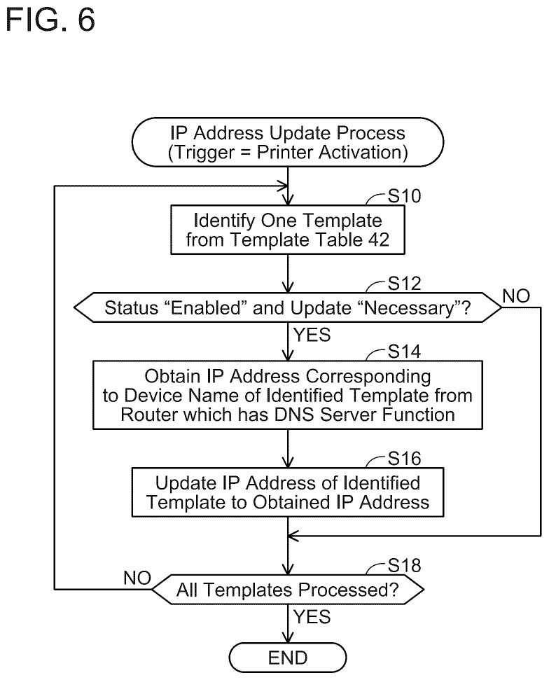

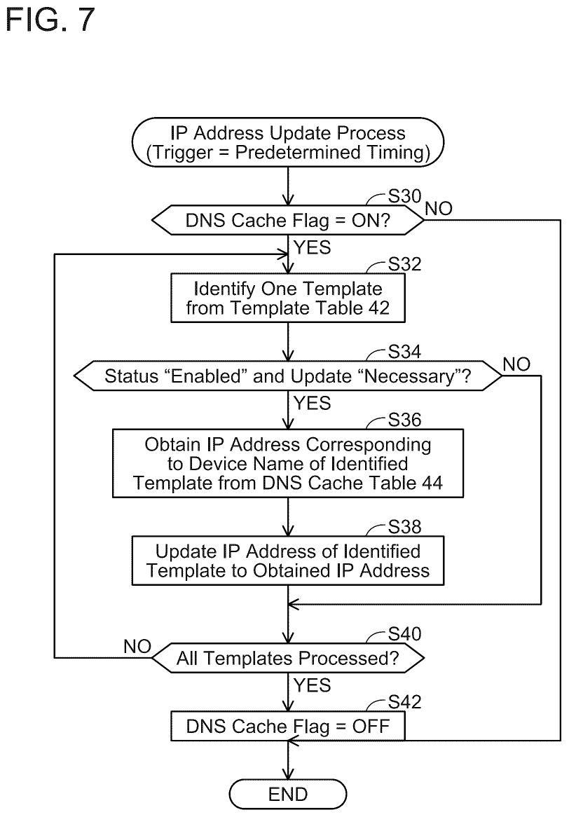

### (IP Address Update Process; FIGS. 6 and 7)

Next, with reference to FIGS. 6 and 7, an IP address update process executed by the CPU 32 of the printer 10 will be described. The IP address update process is a process for updating an IP address included in a template. Between processes of FIG. 6 and FIG. 7, a trigger for starting the processes is different, and also a method for updating is different. The IP address update process of FIG. 6 is started with activation of the printer 10 as a trigger.

In S10, the CPU 32 specifies one template from the template table 42 within the memory 34.

In S12, the CPU 32 determines whether state information included in the specified template is “Enabled”, and also whether update information included in the specified template is “Necessary”. In a case where the state information is “Enabled” and the update information is “Necessary” (YES to S12), the CPU 32 proceeds to S14. Contrary to this, in a case where the state information is “Disabled” or the update information is “Unnecessary” (NO to S12), the CPU 32 proceeds to S18, and in this case, the CPU 32 does not execute processes of S14 and S16 to be described later.

In S14, the CPU 32 sends an inquiry request including the device name included in the specified template to a DNS server (i.e., the router 60) and receives an inquiry response including the IP address associated with such device name, by which the CPU 32 acquires the IP address corresponding to such device name. That is, the CPU 32 executes name resolution.

In S16, the CPU 32 compares the IP address included in the specified template and the IP address acquired in S14, and in a case where they are different, the CPU 32 changes the IP address included in the specified template to the acquired IP address and stores the same. Here, the CPU 32 does not change the IP address in a case where they match.

In S18, the CPU 32 determines whether the processes of and after S10 have been executed for all the template(s) in the template table 42. In a case where the CPU 32 determines that the processes have been executed for all the template(s) (YES to S18), the CPU 32 ends the processes of FIG. 6 whereas in a case where the CPU 32 determines that the processes have not been executed for all the template(s) (NO to S18), the CPU 32 returns to S10.

Next, the IP address update process of FIG. 7 will be described. The IP address update process of FIG. 7 is started with arrival of a predetermined timing as a trigger. The predetermined timing may be for example a predetermined time in a day or may be a timing at which a predetermined update operation is performed by a user.

In S30, the CPU 32 determines whether the DNS cache flag in the memory 34 indicates “ON” or not. In a case where the DNS cache flag indicates “ON” (YES to S30), the CPU 32 proceeds to S32, whereas in a case where the DNS cache flag indicates “OFF” (NO to S30), the CPU 32 ends the processes of FIG. 7.

The processes of S32, S34 are respectively the same as the processes of S10, S12 in FIG. 6. In a case where the state information included in the specified template is “Enabled” and also the update information included in the specified template is “Necessary” (YES to S34), the CPU 32 proceeds to S36. Contrary to this, in a case where the state information is “Disabled” or the update information is “Unnecessary” (NO to S34), the CPU 32 proceeds to S40, and in this case, the CPU 32 does not execute processes of S36 and S38 to be described later.

In S36, the CPU 32 specifies the device name included in the specified template, and acquires the IP address associated with the specified device name from the DNS cache table 44 in the memory 34.

In S38, the CPU 32 compares the IP address included in the template specified in S32 and the IP address acquired in S36 from the DNS cache table 44, and in case where they are different, the CPU 32 changes the IP address included in the specified template to the acquired IP address and stores the same. Here, in a case where they match, the CPU 32 does not change the IP address included in the specified template.

In S40, the CPU 32 determines whether the processes of S32 and after have been executed for all the template(s) in the template table 42. In a case where the CPU 32 determines that the processes have been executed for all the template(s) (YES to S40), the CPU 32 proceeds to a process of S42, whereas in a case where the CPU 32 determines that the processes have not been executed for all the template(s) (NO to S40), the CPU 32 returns to S32.

In S42, the CPU 32 switches the DNS cache flag from “ON” to “OFF”. This ends the processes of FIG. 7.

As mentioned above, the printer 10 executes the IP address update process of changing the IP address of the template which includes the update information “Necessary” in the template table 42 (S16 in FIG. 6, S38 in FIG. 7). Due to this, even when the IP address of the device corresponding to the template is changed, the printer 10 can use the changed IP address.

### (Correspondence Relationships)

The printer 10 is an example of “communication device”. The network 5, the subnetwork 6, and the subnetwork 8 are respectively examples of “local area network”, “specific subnetwork”, and “one or more other subnetworks”. The combination of the IP address and the subnet mask of the printer 10 is an example of “network information”. The terminal 100 and the terminal 200 are respectively examples of “first-type external device”. The printer 300, the terminal 400, and the terminal 500 are respectively examples of “second-type external device”. The display 114 of the terminal 100 is an example of “display”. The template setting screen SC3 in FIG. 4 and the template setting screen SC9 in FIG. 5 are examples of “first selection screen”. The search result screen SC4 in FIG. 4 and the search result screen SC10 and FIG. 5 are respectively examples of “first search result screen” and “second search result screen”. The process of storing a template in T70 or T120 in FIG. 3 is an example of “filter process”. The device name is an example of “name information”. The IP address acquired from the router in S14 in FIG. 6 and the IP address acquired from the DNS cache table 44 in S36 in FIG. 7 are examples of “second IP address”. The router 60 having the DNS server function is an example of “name resolution server”. The DNS cache flag is an example of “update flag”. The DNS cache flag “ON” and the DNS cache flag “OFF” are respectively examples of “first value” and “second value”.

The process of sending the template setting screen data representing the template setting screen SC3 to the terminal 100 and the process of sending the template setting screen data representing the template setting screen SC9 to the terminal 100 are examples of processes executed by “display a first selection screen on a display”. T40 and T42 in FIG. 3 are examples of processes executed by “specify the one or more first-type external devices”. T44 in FIG. 3 is an example of processes executed by “display a first search result screen”. T100 to T104 in FIG. 3 are an example of processes executed by “specify the one or more second-type external devices”. T44 cited after T104 in FIG. 3 is an example of processes executed by “display a second search result screen”. T70 and T120 in FIG. 3 is an example of processes executed by “perform a filter process”. S14 in FIGS. 6 and S36 in FIG. 7 are an example of processes executed by “acquire a second IP address of the specific external device”. S16 in FIGS. 6 and S38 in FIG. 7 are an example of processes executed by “change an IP address stored in the memory in association with the name information of the specific external device”. The process of receiving the plurality of pieces of the combination information of the IP address and the device name from the router 60 and the process of storing the plurality of pieces of the combination information in the DNS cache table 44 are respectively examples of “receive from a name resolution server . . . ” and “store in the memory as a name resolution cache . . . ”.

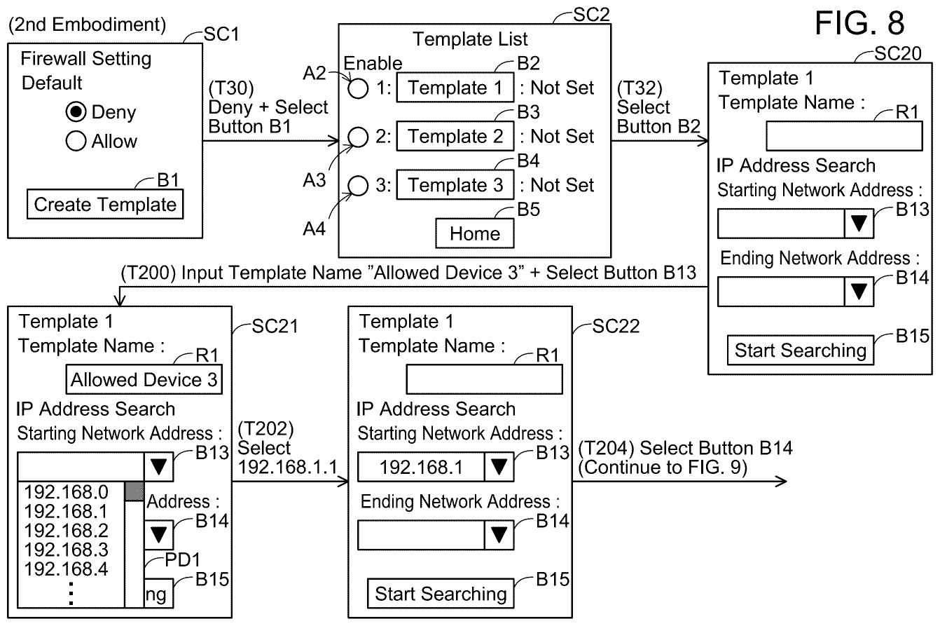

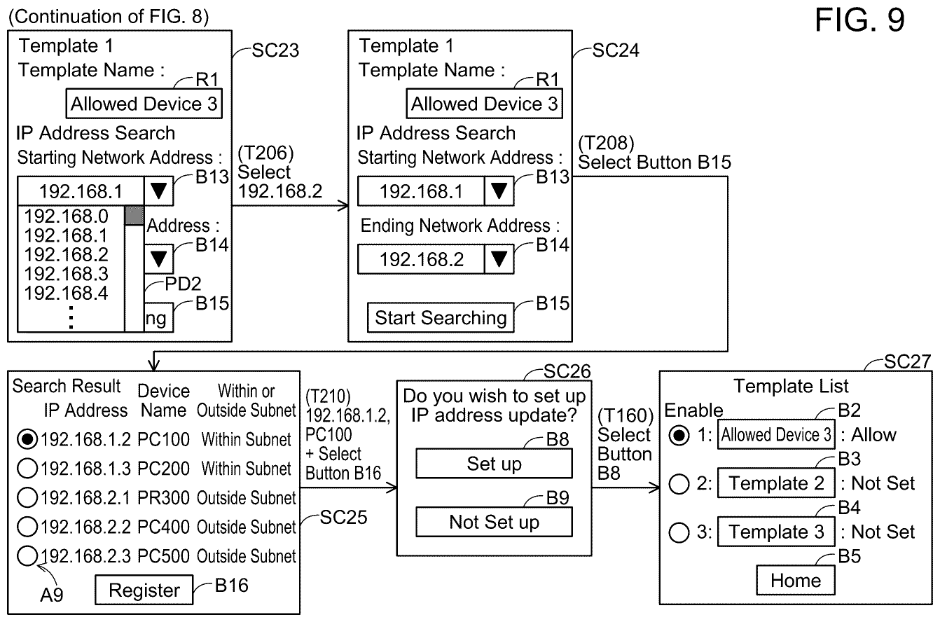

### Second Embodiment; FIGS. 8 and 9

Next, a second embodiment will be described. The present embodiment is different from the first embodiment about the template setting screen and the search result screen. At an initial state of FIG. 8, no information is not stored yet in the template table 42 of the printer 10. In FIGS. 8 and 9, same reference numerals as those of FIGS. 4 and 5 are given to same processes and same screens as those of FIGS. 4 and 5, and descriptions thereof may be omitted.

When the terminal 100 receives the template setting screen data from the printer 10, the terminal 100 displays a template setting screen SC20. As shown in FIG. 8, the template setting screen SC20 includes the template number “1”, a template name input area R1, a button B13 for selecting a starting network address, and a button B14 for selecting an ending network address, and a Start Searching button B15. The buttons B13, B14 are for designating a range of network addresses of a subnetwork to be searched.

Here, before the printer 10 sends the template setting screen data to the terminal 100, the printer 10 specifies the network address “192.168.1” of the subnetwork 6 to which the printer 10 itself belongs, by masking the IP address “192.168.1.1” of the printer 10 itself with the subnet mask “255.255.255.0” of the printer 10. Then, the printer 10 specifies from “192.168.0” to “192.168.255” as a range of the IP addresses including the specified network address “192.168.1”. The printer 10 sends the specified IP address range to the terminal 100 with the template setting screen data.

When in T200 the terminal 100 receives input of a template name “Allowed Device 3” and selection of the button B13 for selecting the starting network address from the user, the terminal 100 displays a template setting screen SC21 including a pulldown PD1. The pulldown PD1 is an area for selecting one IP address from among the above-mentioned range of the IP address “192.168.0” to “192.168.255”. In T202, the terminal 100 receives selection of the IP address “192.168.1”. In this case, a template setting screen SC22 having the network address “192.168.1” selected as the starting network address inputted therein is displayed on the terminal 100.

Next, when in T206 the terminal 100 receives selection of the button B14 for selecting the ending network address from the user, the terminal 100 displays a template setting screen SC23 (see FIG. 9) including a pulldown PD2. The pulldown PD2 is an area for selecting one IP address from among the above-mentioned range of the IP address “192.168.0” to “192.168.255”. In T206, the terminal 100 receives selection of an IP address “192.168.2”. In this case, a template setting screen SC24 having the network address “192.168.2” selected as the ending network address inputted therein is displayed on the terminal 100.

When in T208 the terminal 100 receives selection of the Start Searching button B15 from the user, the terminal 100 sends a search instruction including the starting network address “192.168.1” and the ending network address “192.168.2” to the printer 10.

When the printer 10 receives the search instruction from the terminal 100, the printer 10 sends a broadcast search signal including a broadcast address “192.168.1.255” of the starting network address “192.168.1” and a broadcast address “192.168.2.255” of the ending network address “192.168.2” that are included in the received search instruction as a destination address and also the IP address “192.168.1.1” as a sender address. Due to this, this search signal is received by each of the devices 100, 200 within the subnetwork 6 and each of the devices 300, 400, 500 within the subnetwork 8.

When the printer 10 receives a response signal from each of the terminal 100, the terminal 200, the printer 300, the terminal 400, and the terminal 500, the printer 10 specifies combinations of an IP address and a device name included in the respective response signals. That is, the printer 10 specifies five combinations. Next, the printer 10 specifies two combinations (i.e., “192.168.1.2”—“PC100”, “192.168.1.3”—“PC200”) having a network address matching the network address “192.168.1” of the printer 10 from among the above-mentioned five combinations. Further, the printer 10 specifies three combinations (i.e., “192.168.2.1”—“PR300”, “192.168.2.2”—“PC400”, “192.168.2.3”—“PC500”) having a network address which does not match the network address “192.168.1” of the printer 10 from among the five above-mentioned combinations. Then, the printer 10 sends search result screen data including information indicating the above-mentioned two combinations and “Within Subnet” and information indicating the three above-mentioned combinations and “Outside Subnet” to the terminal 100.

When the terminal 100 receives the search result screen data from the printer 10, the terminal 100 displays a search result screen SC25 represented by the search result screen data. The search result screen SC25 includes the above-mentioned five combinations. The above-mentioned two combinations are associated with a character string indicating “Within Subnet” and the above-mentioned three combinations are associated with a character string indicating “Outside Subnet”. That is, the search result screen SC25 indicates the respective devices within the subnetwork 6 and the respective devices outside the subnetwork 6 in a distinguishable form by which they can be distinguished from each other. The search result screen SC25 further includes a radio button A9 corresponding to each combination and a Register button B16. In T210, the terminal 100 receives selection of the radio button corresponding to the combination of the IP address “192.168.1.2” and the device name “PC100” and selection of the Register button B16 from the user. In this case, the terminal 100 sends the IP address selection result including the IP address “192.168.1.2” and the device name “PC100” to the printer 10. Processes such as T160 and screens SC26, S27, for example are the same as those of the first embodiment.

According to the respective processes, the printer 10 can execute the filter process of denying communication with any device in principle but exceptionally allowing communication with the terminal 100 designated by the template number “1”.

In a case where the “Allow” button is selected by the user on the firewall setting screen SC1 in FIG. 8, that is, in a case where “Allow” is designated as the default policy of the printer 10, the respective screens of FIGS. 8 and 9 are displayed. In this case, the printer 10 stores the filter information indicating “Deny”, which is opposite from “Allow”, in the template storing process. That is, the printer 10 can execute the filter process of allowing communication with any device in principle but exceptionally denying communication with the terminal 100 designated by the template number “1”.

### Effects of Present Embodiment

According to the above configuration, the printer 10 specifies the respective devices 100, 200 within the subnetwork 6 and the respective devices 300, 400, 500 within the subnetwork 8 by sending the broadcast search signal to each of the network addresses between the starting network address and the ending network address that are designated by the user. Then the printer 10 displays the search result screen SC25 including the respective specified combinations on the display 114 of the terminal 100. Here, in the search result screen SC25, the respective devices within the subnetwork 6 and the respective devices outside the subnetwork 6 are indicated in the distinguishable form. Due to this, the user can firstly acknowledge the respective devices 100, 200 within the subnetwork 6 to which the printer 10 belongs and the respective devices 300, 400, 500 within the subnetwork 8 different from the subnetwork 6 on the search result screen SC25, and can select a device to be a target for the filter process (i.e., the terminal 100). Accordingly, user convenience can be improved.

### (Correspondence Relationships)

The process of the printer 10 executed according to the selection of the Start Searching button B15 in FIG. 9 is an example of processes executed by “specify, by sending a search signal to outside, a plurality of external devices . . . ”. Thereafter, the process of the printer 10 specifying the respective devices within the subnetwork 6 and the respective devices outside the subnetwork 6 is an example of processes executed by “specify . . . one or more first-type external devices . . . ”. The process of the printer 10 sending the search result screen data to the terminal 100 is an example of processes executed by “display a search result screen . . . ”. The process of storing the template is an example of processes executed by “ . . . perform a filter process related to whether to allow communication with the specific external device”.

While the invention has been described in conjunction with various example structures outlined above and illustrated in the figures, various alternatives, modifications, variations, improvements, and/or substantial equivalents, whether known or that may be presently unforeseen, may become apparent to those having at least ordinary skill in the art. Accordingly, the example embodiments of the disclosure, as set forth above, are intended to be illustrative of the invention, and not limiting the invention. Various changes may be made without departing from the spirit and scope of the disclosure. Therefore, the disclosure is intended to embrace all known or later developed alternatives, modifications, variations, improvements, and/or substantial equivalents. Some specific examples of potential alternatives, modifications, or variations in the described invention are provided below.

### (Modification 1)

When in T36 in FIG. 3 the printer 10 receives the ‘search within subnet’ instruction from the terminal 100, in T38 the printer 10 may send the search signal by using a broadcast address corresponding to all the networks within the network 5. In this case, the search signal is received by each of the devices 100, 200, 300, 400, 500 within the network 5. Thereafter, when the printer 10 receives the response signal from each of the devices 100, 200, 300, 400, 500, the printer 10 specifies the network address “192.168.1” by using the IP address “192.168.1.1” and the subnet mask “255.255.255.0” of the printer 10. Then, the printer 10 specifies two devices 100, 200 within the subnetwork 6 by specifying two response signals including the specified network address “192.168.1” from the respective response signals. The present process is an example of processes executed by “ . . . specify the one or more first-type external devices . . . ”.

### (Modification 2)

In the search result screen SC4 of FIG. 4, the search result screen SC10 of FIG. 5, and the search result screen SC25 of FIG. 9, an IP address only may be displayed or a device name only may be displayed instead of the combinations of the IP address and the device name of each device. Also, the printer 10 may further execute communication (e.g., Simple Network Management Protocol (SNMP)) with each device to be displayed on the search result screen SC4, for example, and may receive model information of each device. In this case, on the search result screen SC4 for example, the model information only may be displayed, or the IP address and/or the device name may be displayed in addition to the model information. In general terms, “first search result screen” and/or “second search result screen” and/or “search result screen” simply need to include at least one of the name information, the IP address, and the model information.

### (Modification 3)

The template setting screen SC9 of FIG. 5 may not include the network address input area R2. In this case, in T96 in FIG. 3, the printer 10 receives the ‘search outside subnet’ instruction including information indicating that the “Outside Subnet” button has been selected but not including a network address from the terminal 100. In T98 the printer 10 designates “192.168.255” from “192.168.0” and “192.168.2” other than the network address “192.168.1” of the printer 10 itself, and designates a host address as a broadcast address (i.e., 255) and then sends a search signal. In general terms, “ . . . specify the one or more second-type external devices by sending a search signal to outside” may not use the subnetwork designated by the user to specify the one or more second-type external devices.

### (Modification 4)

The template setting screen SC9 in FIG. 5 may not include the network address input area R2. In this case, in T96 in FIG. 3, the printer 10 receives the ‘search outside subnet’ instruction which includes information indicating that the “Outside Subnet” button has been selected but does not include a network address from the terminal 100. Then in T98 the printer 10 may send a search signal by using a broadcast address corresponding to all the networks within the network 5. In this case, the search signal is received by each of the devices 100, 200, 300, 400, 500 within the network 5. Thereafter, when the printer 10 receives the response signal from each of the devices 100, 200, 300, 400, 500, the printer 10 specifies the network address “192.168.1” by using the IP address “192.168.1.1” and the subnet mask “255.255.255.0” of the printer 10. Then, the printer 10 specifies the three devices 300, 400, 500 outside the subnetwork 6 by specifying the three response signals including a network address other than the specified network address “192.168.1” from the respective response signals. The present process is an example of processes executed by “ . . . specify the one or more second-type external devices by sending a search signal to outside”.

### (Modification 5)

The template setting screen SC20 in FIG. 8 may not include the button B13 for selecting the starting network address and the button B14 for selecting the ending network address. In this case, the printer 10 may send a broadcast search signal in response to the Start Searching button B15 (see FIG. 9) being selected. The present process is also an example of processes executed by “specify, by sending a search signal to outside, a plurality of external devices . . . ”. Then, similar to the above-mentioned modifications 1 and 4, the printer 10 specifies the two devices 100, 200 within the subnetwork 6 and the three devices 300, 400, 500 outside the subnetwork 6. The present process is also an example of processes executed by “specify . . . one or more first-type external devices . . . ”.

### (Modification 6)

The processes of FIGS. 6 and 7 may be omitted. In this case, the update information may be omitted in the template table 42. In the present modification, “acquire a second IP address . . . ” and “change an IP address stored in the memory in association with the name information of the specific external device from the first IP address to the second IP address” may be omitted.

### (Modification 7)

The printer 10 may store the network address itself of the subnetwork 6 to which the printer 10 itself belongs. In the present modification, the network address itself is an example of “network information”.

### (Modification 8)

In the above-described embodiments, the processes of each step in FIGS. 3 to 9 are realized by software (e.g., the program 40 of the printer 10), but at least one of these processes may be realized by hardware such as a logic circuitry.

What is claimed is:

1. A communication device, comprising:
a controller; and
a memory configured to, in a case where the communication device belongs to a specific subnetwork among a plurality of subnetworks constituting a local area network, store network information capable of specifying a network address of the specific subnetwork,
wherein the controller is configured to:
display a first selection screen on a display, the first selection screen being for selecting whether to search for one or more first-type external devices belonging to the specific subnetwork or for one or more second-type external devices belonging to a subnetwork different from the specific subnetwork in the plurality of subnetworks;
in a case where it is selected on the first selection screen by a user that the one or more first-type external devices are to be searched for, specify the one or more first-type external devices by using the network information in the memory and also by sending a search signal to outside;
in a case where the one or more first-type external devices are specified, display a first search result screen indicating the one or more first-type external devices on the display;
in a case where it is selected on the first selection screen by the user that the one or more second-type external devices are to be searched for, specify the one or more second-type external devices by sending a search signal to outside;
in a case where the one or more second-type external devices are specified, display a second search result screen indicating the one or more second-type external devices on the display; and
in a case where a specific external device is selected on the first search result screen or the second search result screen, perform a filter process related to whether to allow communication with the specific external device.

2. The communication device as in claim 1, wherein the first search result screen includes, for each of the one or more the first-type external devices, at least one of name information of the external device, an IP address of the external device, and model information of the external device, and
the second search result screen includes, for each of the one or more second-type external devices, at least one of name information of the external device, an IP address of the external device, and model information of the external device.

3. The communication device as in claim 1, wherein in a case where it is selected on the first selection screen by the user that the one or more second-type external devices are to be searched for and a network address of the subnetwork different from the specific subnetwork in the plurality of subnetworks is designated by the user, the controller is configured to specify the one or more second-type external devices by using the designated network address and also by sending the search signal to outside.

4. The communication device as in claim 1, wherein the filter process includes storing in the memory a first IP address of the specific external device in association with name information of the specific external device,
the controller is further configured to:
acquire a second IP address of the specific external device by using the name information of the specific external device after the filter process is performed; and
change an IP address stored in the memory in association with the name information of the specific external device from the first IP address to the second IP address.

5. The communication device as in claim 4, wherein the second IP address is acquired from a name resolution server by sending the name information of the specific external device to the name resolution server.

6. The communication device as in claim 4, wherein the controller is further configured to:
receive from a name resolution server, for each of one or more external devices including the specific external device, name information of the external device and an IP address of the external device; and
store in the memory as a name resolution cache, for each of the one or more external devices including the specific external device, the name information of the external device and the IP address of the external device in association with each other,
wherein the second IP address stored in the memory in association with the name information of the specific external device is acquired from the name resolution cache in the memory.

7. The communication device as in claim 4, wherein the filter process includes storing in the memory the name information of the specific external device, the first IP address of the specific external device, and an update flag according to user selection in association with each other, and
the update flag indicates one of a first value corresponding to updating of an IP address and a second value corresponding to not updating of an IP address,
in a case where the update flag indicates the first value, the second IP address is acquired, and the IP address stored in the memory in association with the name information of the specific external device is changed from the first IP address to the second IP address, and
in a case where the update flag indicates the second value, the second IP address in not acquired, and the IP address stored in the memory in association with the name information of the specific external device is not changed from the first IP address to the second IP address.

8. The communication device as in claim 1, wherein the network information includes an IP address of the communication device and a subnet mask of the communication device.

9. A communication device, comprising:
a controller; and
a memory configured to, in a case where the communication device belongs to a specific subnetwork among a plurality of subnetworks constituting a local area network, store network information capable of specifying a network address of the specific subnetwork,
wherein the controller is configured to:
specify, by sending a search signal to outside, a plurality of external devices, each of which belongs to the specific subnetwork or one or more other subnetworks different from the specific subnetwork in the plurality of subnetworks;
specify from among the plurality of external devices, by using the network information in the memory, one or more first-type external devices belonging to the specific subnetwork and one or more second-type external devices belonging to the one or more other subnetworks;
display a search result screen on a display, the search result screen indicating the one or more first-type external devices and the one or more second-type external devices in a distinguishable form by which the one or more first-type external devices and the one or more second-type external devices are distinguishable; and
in a case where a specific external device is selected on the search result screen, perform a filter process related to whether to allow communication with the specific external device.

10. The communication device as in claim 9, wherein the search result screen includes, for each of the plurality of external devices, at least one of name information of the external device, an IP address of the external device, and model information of the external device.

11. The communication device as in claim 9, wherein, in a case where the network address of the specific subnetwork and one or more network addresses of the one or more other subnetworks are designated by the user, the controller is configured to specify the plurality of external devices by using two or more designated network addresses and also by sending the search signal to outside.

12. The communication device as in claim 9, wherein the filter process includes storing in the memory a first IP address of the specific external device in association with name information of the specific external device,
the controller is further configured to:
acquire a second IP address of the specific external device by using the name information of the specific external device after the filter process is performed; and
change an IP address stored in the memory in association with the name information of the specific external device from the first IP address to the second IP address.

13. The communication device as in claim 12, wherein the second IP address is acquired from a name resolution server by sending the name information of the specific external device to the name resolution server.

14. The communication device as in claim 12, wherein the controller is further configured to:
receive from a name resolution server, for each of one or more external devices including the specific external device, name information of the external device and an IP address of the external device; and
store in the memory as a name resolution cache, for each of the one or more external devices including the specific external device, the name information of the external device and the IP address of the external device in association with each other,
wherein the second IP address stored in the memory in association with the name information of the specific external device is acquired from the name resolution cache in the memory.

15. The communication device as in claim 12, wherein the filter process includes storing in the memory the name information of the specific external device, a first IP address of the specific external device, and an update flag according to user selection in association with each other,
the update flag indicates one of a first value corresponding to updating of an IP address and a second value corresponding to not updating of an IP address,
in a case where the update flag indicates the first value, the second IP address is acquired, and the IP address stored in the memory in association with the name information of the specific external device is changed from the first IP address to the second IP address, and
in a case where the update flag indicates the second value, the second IP address in not acquired, and the IP address stored in the memory in association with the name information of the specific external device is not changed from the first IP address to the second IP address.

16. The communication device as in claim 9, wherein the network information includes an IP address of the communication device and a subnet mask of the communication device.

17. A non-transitory computer-readable storage medium storing computer-readable instructions for a communication device, wherein the communication device comprises:
a processer; and
a memory configured to, in a case where the communication device belongs to a specific subnetwork among a plurality of subnetworks constituting a local area network, store network information capable of specifying a network address of the specific subnetwork,
the computer-readable instructions, when executed by the processor of the communication device, cause the communication device to:
display a first selection screen on a display, the first selection screen being for selecting whether to search for, one or more first-type external devices belonging to the specific subnetwork or for one or more second-type external devices belonging to a subnetwork different from the specific subnetwork in the plurality of subnetworks;
in a case where it is selected on the first selection screen by a user that the one or more first-type external devices are to be searched for, specify the one or more first-type external devices by using the network information in the memory and also by sending a search signal to outside;
in a case where the one or more first-type external devices are specified, display a first search result screen indicating the one or more first-type external devices on the display;
in a case where it is selected on the first selection screen by the user that the one or more second-type external devices are to be searched for, specify the one or more second-type external devices by sending a search signal to outside;
in a case where the one or more second-type external devices are specified, display a second search result screen indicating the one or more second-type external devices on the display; and
in a case where a specific external device is selected on the first search result screen or the second search result screen, perform a filter process related to whether to allow communication with the specific external device.

18. A non-transitory computer-readable storage medium storing computer-readable instructions for a communication device, wherein the communication device, comprises:
a processer; and
a memory configured to, in a case where the communication device belongs to a specific subnetwork among a plurality of subnetworks constituting a local area network, store network information capable of specifying a network address of the specific subnetwork,
the computer-readable instructions, when executed by the processor of the communication device, cause the communication device to:
specify, by sending a search signal to outside, a plurality of external devices each of which belongs to the specific subnetwork or one or more other subnetworks different from the specific subnetwork in the plurality of subnetworks;
specify from among the plurality of external devices, by using the network information in the memory, one or more first-type external devices belonging to the specific subnetwork and one or more second-type external devices belonging to the one or more other subnetworks;
display a search result screen on a display, the search result screen indicating the one or more first-type external devices and the one or more second-type external devices in a distinguishable form by which the one or more first-type external devices and the one or more second-type external devices are distinguishable; and
in a case where a specific external device is selected on the search result screen, perform a filter process related to whether to allow communication with the specific external device.
